(19) United States
(12) Patent Application Publication
(10) Pub. No.: US 2006/0035689 A1
(43) Pub. Date: Feb. 16, 2006

(54) Tone-based wireless remote control

(76) Inventor: Pony Lei, Hsinchu (TW)

Correspondence Address: HERSHKOVITZ & ASSOCIATES, 1725 I STREET NW, SUITE 300, WASHINGTON, DC, 20006, US

(21) Appl. No.: 10/916,528

(22) Filed: Aug. 12, 2004

(51) Int. Cl. H04B 1/10; H04B 7/00

(52) U.S. Cl. 455/701

(57) ABSTRACT

A tone-based wireless remote control has a tone decoder operated in association with a mobile phone/telephone. When a user presses keys of the phone to generate different tones, these tones are received by the tone decoder and further converted to digital signals. A microprocessor of the tone decoder recognizes the digital signals and accordingly produces a remote control code. The remote control code is subsequently transmitted to an electrical product to accomplish a desired operation.

### BACKGROUND OF THE INVENTION

1. Field of the Invention

The present invention relates to a tone-based wireless remote control, and more particularly to a wireless remote control using keys of a phone as an operating interface, wherein the wireless remote control controls various electrical products by recognizing different tones generated when the keys are pressed.

2. Description of Related Art

People nowadays are used to operating electrical products such as a TV, an air conditioner, a video player, a door of a garage and a vehicle burglar alarm simply by pressing control buttons of a wireless remote control. Since each electrical product has its unique remote control, for people who operate these remote controls, it is inconvenient for them to select one among these remote controls. Meanwhile, another problem is to keep these numerous remote controls in a tidy fashion and without losing them.

Therefore, the invention provides a novel tone-based wireless remote control to mitigate or obviate the aforementioned problems.

### SUMMARY OF THE INVENTION

The main objective of the present invention is to provide a tone-based wireless remote control that adopts the widely-used telephone, a wireless home phone or a cellular phone as an operating interface in accompaniment with tone recognizing technology to control various electrical products.

To accomplish the objective, the tone-based wireless remote control uses a phone that is operated in associated with a tone decoder, wherein the tone decoder comprises:
a sound receiver receiving DTMF signals when any key of the phone is pressed;
a DTMF decoder coupled to the sound receiver to convert the DTMF signals to digital signals;
a microprocessor coupled to the DTMF decoder to encrypt the digital signals to a specific remote control code; and
an amplifying and emitting circuit coupled to the microprocessor to retrieve the encoded remote control code, wherein the amplifying and emitting circuit provides a carrier wave over the encoded remote control code and then transmits the remote control code to an electrical product to be controlled.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a tone-based wireless remote control according to a first embodiment of the present invention;

FIG. 2 is a perspective view of a tone-based wireless remote control according to a second embodiment of the present invention;

FIG. 3 is a block diagram of a tone detector in accordance with the present invention;

FIG. 4 is a circuit diagram of the tone detector of FIG. 3;

FIG. 5 is a block diagram of a signal decoder in accordance with the present invention; and

FIG. 6 a circuit diagram of the signal decoder of FIG. 5.

### DETAILED DESCRIPTION OF THE PREFERRED EMBODIMENT

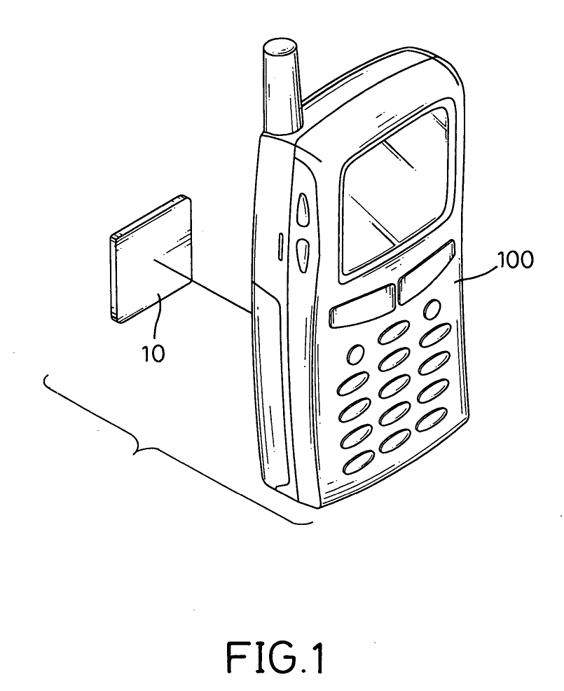

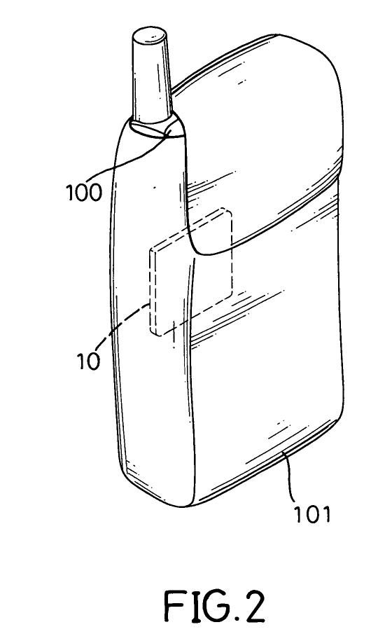

With reference to FIG. 1, a tone-based wireless remote control in accordance with the present invention comprises a phone (100) and a tone decoder (10) adjacent to the phone (100), for example within 10 centimeters. The tone decoder (10) may preferably be mounted at a back of the phone (100). Therefore, the tone detector (10) is able to receive generated DTMF (dual-tone multifrequency) audio signals while pressing keys of the phone (100). Another manner to arrange the tone is shown in FIG. 2. The tone decoder (10) is put in a sheath (101) used to protective the phone (100). It is noted that the arrangement of the tone decoder (10) shown in FIGS. 1 and 2 is for exemplary purpose only. The tone decoder (10) can be arranged in any way to adjacent to the phone (100). The phone (100) can be selected from a regular telephone, a wireless household phone, or a cellular phone.

When pressing any one of the keys on the phone (100), a unique DTMF audio signal, also known as the tone, is accordingly generated. Different keys will generate different tone signals. Based on this characteristic, the phone (100) is used as an operating interface allowing a user to press its keys thereby generating particular tones to control a designated electrical instrument to perform a specific function. A combination of tones produced by different number keys is corresponded to a specific remote control command. After the tone decoder (10) receives the combination of the tones, the tone decoder (10) can generate a remote control signal and then transmit the remote control signal to a specific electrical product.

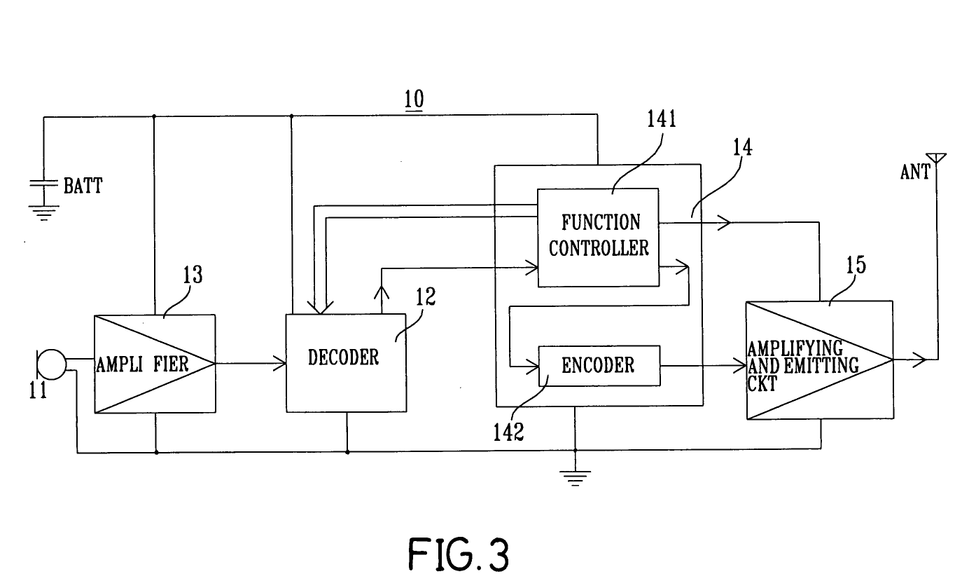

With reference to FIG. 3, the tone decoder (10) comprises a sound receiver (11), a DTMF decoder (12), an amplifier (13), a microprocessor (14) and an amplifying and emitting circuit (15).

The sound receiver (11), such as microphone, is provided to receive DTMF signals when any key of the phone (100) is pressed.

The DTMF decoder (12), coupled to the sound receiver (11) through the amplifier (13) converts the amplified DTMF signals to digital signals.

The microprocessor (14) is composed of a function controller (141) and an encoder (142). The function controller (141) encrypts the digital signals to a specific remote control code. The remote control code is further encoded by the encoder (142).

The amplifying and emitting circuit (15) is coupled to an output terminal of the microprocessor (14) to retrieve the encoded remote control code. The amplifying and emitting circuit (15) subsequently provides a carrier wave over the encoded remote control code and then transmits the remote control code. The transmitted signals may be in the form of infrared signals or RF signals.

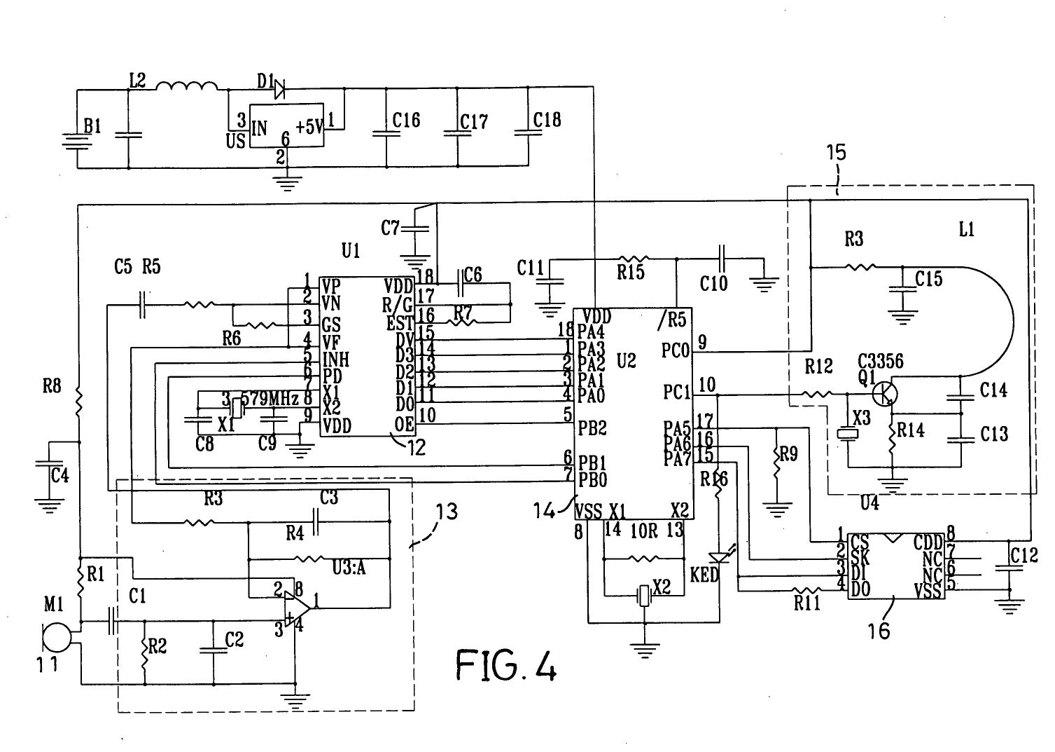

With reference to FIG. 4, the microprocessor (14) is further connected to a memory (16) in which default remote control codes are stored. In the embodiment, the emitted signals of the amplifying and emitting circuit (15) are the RF signals.

When a user presses the keys mounted on the phone (100), the DTMF signals are able to be received by the sound receiver (11), amplified and converted to digital signals. The remote control code generated by the microprocessor (14) is then emitted to a control desired electrical product.

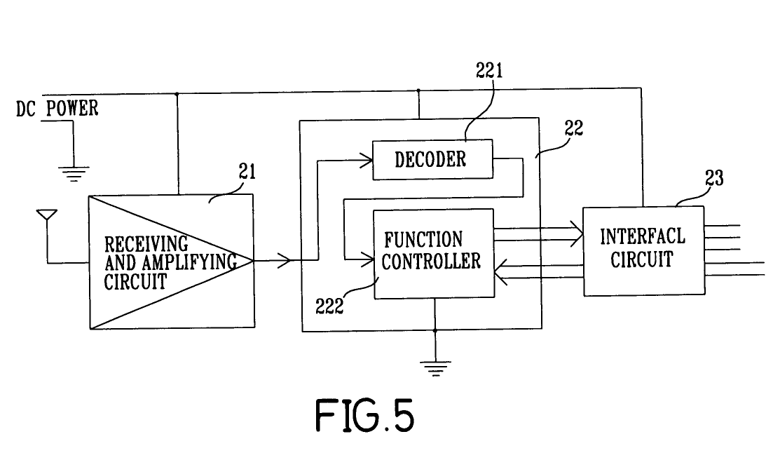

The electrical product to be controlled can alternatively utilize its own signal receiver to receive the remote control codes, or an independent signal decoder as shown in FIG. 5.

The decoder has a receiving and amplifying circuit (21), a microprocessor (22) and an interface circuit (23).

The receiving and amplifying circuit (21) is to receive and amplify the remote control codes emitted from the tone decoder (10).

The microprocessor (22) is formed by a decoder (221) and a function controller (222), wherein the remote control codes are decoded by the decoder (221) to become digital signals. The digital signals are then input to the function controller (222) to derive output signals for performing a specific function.

The interface circuit (23) is coupled between the microprocessor (22) and the electrical product to be controlled. Therefore, the output signals from the microprocessor (22) are applied to the electrical product to perform the specific function.

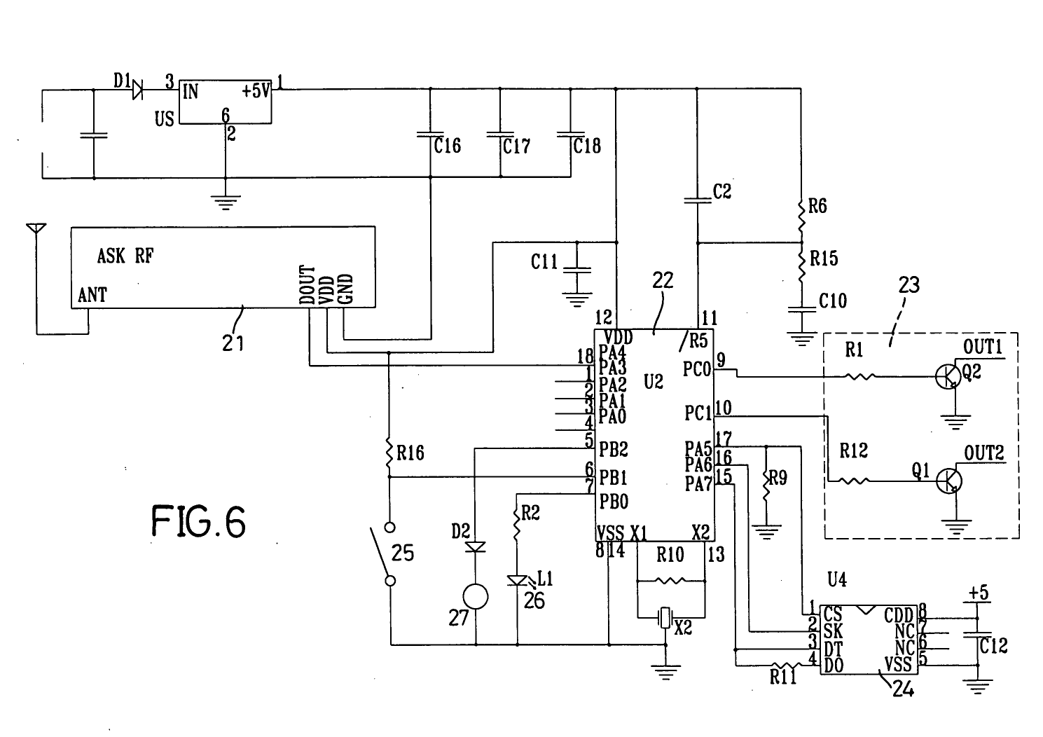

With reference to FIG. 6, the microprocessor (22) is further connected to a memory (24) in which default remote control codes are stored. Furthermore, the microprocessor (22) is coupled to a switch (25), an indicating light (26) and a buzzer (27). The switch (25) is used to switch between a normal use operation mode and a learning mode. When the switch (25) has any switching action, the buzzer (27) will generate sounds. The indicating light (26) is applied to show operating status of the decoder.

The tone-based wireless remote control of the present invention utilizes the common cellular phones, wireless household phones or regular telephones as an operating interface, and in accompaniment with a tone decoder to allow a combination of numbers representing a specific control code so that an electrical instrument is able to be controlled. Through the use of the present invention, people can operate any product in a particularly convenient manner and the amount of the conventional remote controls is efficiently reduced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claim ed is:

1. A tone-based wireless remote control comprising a phone (100) operated in associated with a tone decoder (10), wherein the tone decoder comprises:
a sound receiver (11) receiving DTMF signals when any key of the phone is pressed;
a DTMF decoder (12) coupled to the sound receiver (11) to convert the DTMF signals to digital signals;
a microprocessor (14) coupled to the DTMF decoder (12) to encrypt the digital signals to a specific remote control code; and
an amplifying and emitting circuit (15) coupled to the microprocessor (14) to retrieve the encoded remote control code, wherein the amplifying and emitting circuit (15) provides a carrier wave over the encoded remote control code and then transmits the remote control code to an electrical product to be controlled.

2. The tone-based wireless remote control as claimed in claim 1, wherein the microprocessor (14) comprises a function controller (141) and an encoder (142).

3. The tone-based wireless remote control as claimed in claim 2, wherein the microprocessor (14) further connects to a memory (16).

4. The tone-based wireless remote control as claimed in claim 1, wherein, the transmitted remote control code is an RF signal.

5. The tone-based wireless remote control as claimed in claim 1, wherein, the sound receiver (11) is coupled to the DTMF decoder through an amplifier (13).

6. The tone-based wireless remote control as claimed in claim 1, wherein, the transmitted remote control code from the tone decoder (10) is received by a signal decoder that comprises:
a receiving and amplifying circuit (21) receiving and amplifying the remote control codes emitted from the tone decoder (10);
a microprocessor (22) to decode the remote control codes to become digital signals, wherein the digital signals are then converted to derive output signals for performing a specific function; and
an interface circuit (23) for coupling between the microprocessor (22) and the electrical product to be controlled, whereby the output signals from the microprocessor (22) are applied to the electrical product through the interface circuit (23).

7. The tone-based wireless remote control as claimed in claim 6, wherein the microprocessor (22) comprises a decoder (221) and a function controller (222).

8. The tone-based wireless remote control as claimed in claim 7, wherein the microprocessor (22) further connects to a memory (24).

9. The tone-based wireless remote control as claimed in claim 8, wherein the microprocessor (22) further connects to a switch (25) and a buzzer (27).

10. The tone-based wireless remote control as claimed in claim 9, wherein the microprocessor (22) further connects to an indicating light (26).

11. The tone-based wireless remote control as claimed in claim 1, wherein the phone is a cellular phone.

12. The tone-based wireless remote control as claimed in claim 1, wherein the phone is a regular telephone.

13. The tone-based wireless remote control as claimed in claim 1, wherein the phone is a wireless household telephone.
